(19) United States
(12) Patent Application Publication
(10) Pub. No.: US 2025/0245569 A1
(43) Pub. Date: Jul. 31, 2025

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: Sohi KODAMA, Kanagawa (JP)

(21) Appl. No.: 19/034,894

(22) Filed: Jan. 23, 2025

(30) Foreign Application Priority Data
Jan. 31, 2024 (JP) 2024-013304

(51) Int. Cl. G06N 20/00

(52) U.S. Cl. CPC G06N 20/00

(57) ABSTRACT

An information processing apparatus that can communicate with another information processing apparatus, the information processing apparatus comprising: an acquisition unit configured to acquire information about a trained AI model from the other information processing apparatus; an evaluation unit configured to evaluate the trained AI model; and a determination unit configured to, based on a result of the evaluation by the evaluation unit, determine a publication range within which the information processing apparatus will publish the trained AI model.

### BACKGROUND OF THE INVENTION

### Field of the Invention

The present invention relates to an information processing apparatus, a method for controlling an information processing apparatus, and a storage medium, and particularly relates to a technique for training a plurality of artificial intelligence (AI) tasks.

### Description of the Related Art

The spread of AI has given rise to concerns that discrimination between races, genders, etc., may be observed in AI determination results, that humans may be erroneously detected as animals in AI determination results, etc., and, as a countermeasure against such concerns, there is a global movement toward the formulation of AI ethics. Moreover, AI ethics may differ depending on country, region, etc.

Recent years have seen an increase in cases where ordinary users, as well as companies and organizations, create AI models to fit his/her purpose. Furthermore, there are Internet services allowing ordinary users to publish and acquire machine-trained AI models that they have created to and from one another, and, once a model is published, the model is available for use by many users.

Japanese Patent Laid-Open No. 2021-33707 is an example of related art.

However, an AI model created by a user may fail to sufficiently comply with AI ethics. In such a case, when the AI model is published on a server and made available for use by users around the world, AI-ethics-related problems may occur in the market due to results output by the AI model. For example, problems may occur such as that in which, even though the model is for automatically focusing on a specific person, the model automatically focuses on other animals.

### SUMMARY OF THE INVENTION

The present invention has been made in view of the above-described problem, and provides a technique for reducing the risk of AI-ethics-related problems occurring due to an AI model published by a user.

According to one aspect of the present invention, there is provided an information processing apparatus that can communicate with another information processing apparatus, the information processing apparatus comprising: an acquisition unit configured to acquire information about a trained AI model from the other information processing apparatus; an evaluation unit configured to evaluate the trained AI model; and a determination unit configured to, based on a result of the evaluation by the evaluation unit, determine a publication range within which the information processing apparatus will publish the trained AI model.

Further features of the present invention will become apparent from the following description of exemplary embodiments (with reference to the attached drawings).

### BRIEF DESCRIPTION OF THE DRAWINGS

FIG. 1 is a hardware configuration diagram of a server-side information processing apparatus in an information processing system according to one embodiment.

FIG. 2 is a hardware configuration diagram of a user-side information processing apparatus in the information processing system according to one embodiment.

FIG. 3 is a configuration diagram of the information processing system according to one embodiment.

FIG. 4 is a functional block diagram of the information processing system according to one embodiment.

FIG. 5A-5C are functional block diagrams of a publication-range determination unit according to one embodiment.

FIG. 6 is a flowchart illustrating a procedure of processing executed by the information processing apparatuses according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the present embodiment, an example will be described in which information about a trained AI model is acquired from a user-side information processing apparatus and evaluated, and, based on the result of the evaluation, a publication range within which a server-side information processing apparatus will publish the trained AI model is determined.

### Server-side Hardware Configuration

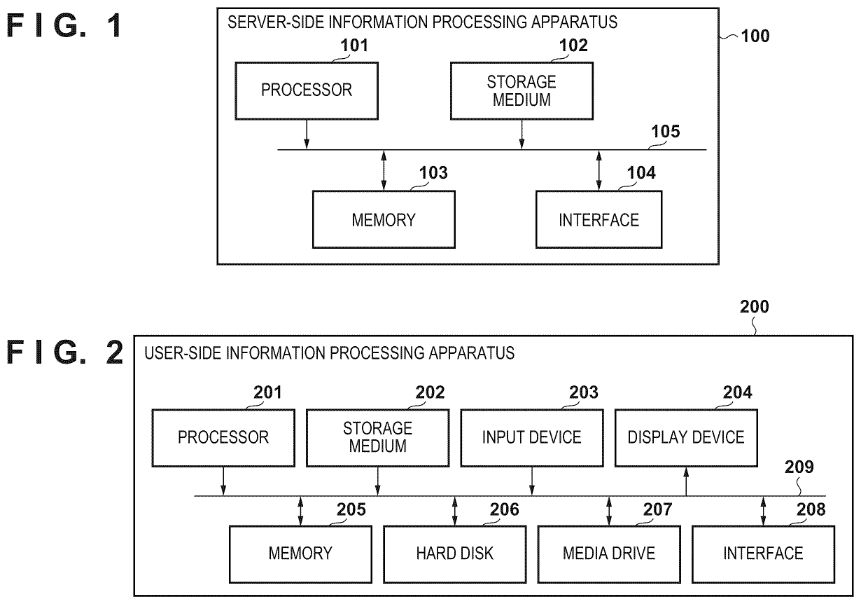

FIG. 1 is a hardware configuration diagram of a server-side information processing apparatus 100 in an information processing system according to the present embodiment.

The information processing apparatus 100 includes a processor 101, a storage medium 102, a memory 103, and an interface 104, and the components are connected to one another via a system bus 105. The information processing apparatus 100 is configured on a cloud server.

The processor 101 is formed from one or more CPUs, for example, and controls various devices connected to the system bus 105. The storage medium 102 is a ROM, for example, and stores therein a Basic Input/Output System (BIOS) program and a boot program. The memory 103 is a RAM, for example, and is used as the primary storage device of the processor 101, which is formed from one or more CPUs. The interface 104 communicates information via a network. The communication performed by the interface 104 may be Ethernet (registered trademark) based, but the type thereof is not limited and may be USB, serial communication, wireless communication, etc.

### User-Side Hardware Configuration

FIG. 2 is a hardware configuration diagram of a user-side information processing apparatus 200 in the information processing system according to the present embodiment.

The information processing apparatus 200 includes a processor 201, a storage medium 202, an input device 203, a display device 204, a memory 205, a hard disk 206, a media drive 207, and an interface 208, and the components are connected to one another via a system bus 209. The information processing apparatus 200 is a terminal apparatus on which a user views a screen and performs operations, and is a personal computer (PC) or a tablet terminal, for example.

The processor 201 is formed from one or more CPUs, for example, and controls various devices connected to the system bus 209. The storage medium 202 is a ROM, for example, and stores therein a BIOS program and a boot program. The input device 203 is a touch panel, a keyboard, a mouse, and/or a robot controller, for example, and performs processing relating to the input of information, etc. The display device (204) outputs results of computation by the information processing apparatus 200 and display information transmitted from the server-side information processing apparatus 100 in accordance with instructions from one or more CPUs (201). Note that the display device 204 may be a liquid-crystal display device, a projector, an LED indicator, or the like, and may be of any type.

The memory 205 is a RAM, for example, and is used as the primary storage device of the processor 201. The hard disk 206 is used to store and read application programs, data, libraries, etc. The media drive 207 allows data in the hard disk 206 to be written to a removable storage medium. This allows the written data to be transferred to an external digital still camera, PC, or tablet terminal.

The interface 208 communicates information via a network, and communicates with the server-side information processing apparatus 100, for example. The communication performed by the interface 208 may be Ethernet (registered trademark) based, but the type thereof is not limited and may be USB, serial communication, wireless communication, etc.

### Configuration of Information Processing System

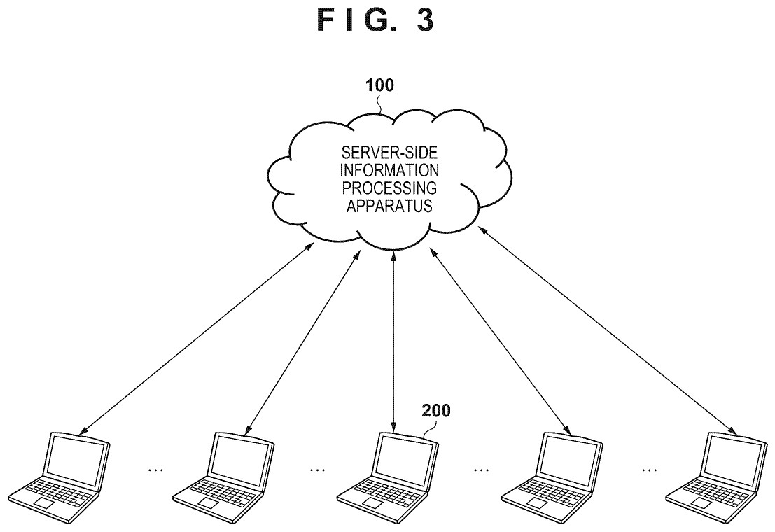

FIG. 3 is a configuration diagram of the information processing system according to the present embodiment. As illustrated in FIG. 3, the server-side information processing apparatus 100 is connected to a plurality of user-side (client-side) information processing apparatuses 200, and performs data transmission/reception and control of display information.

In the present embodiment, description will be provided of an example in which it is determined whether or not an AI model trained by a user sufficiently complies with AI ethics (sufficient to the extent that the risk is low of future issues occurring; not intended to guarantee 100% compliance), and users to which the AI model is to be published are determined based on the result of the determination. In the present embodiment, description is provided taking as an example a case in which one user has created an object detection model for detecting a specific person and is planning to publish the model. Hereinafter, the model trained by the user is referred to as a “trained model”. Note that the object detection AI model for detecting a specific person is merely one example, and there is no limitation to this. Besides this, for example, object detection tasks for detecting races, animals, vehicles, or the like, speech recognition, generative AI such as chatbots, etc., are also conceivable.

### Functional Configuration of Information Processing System

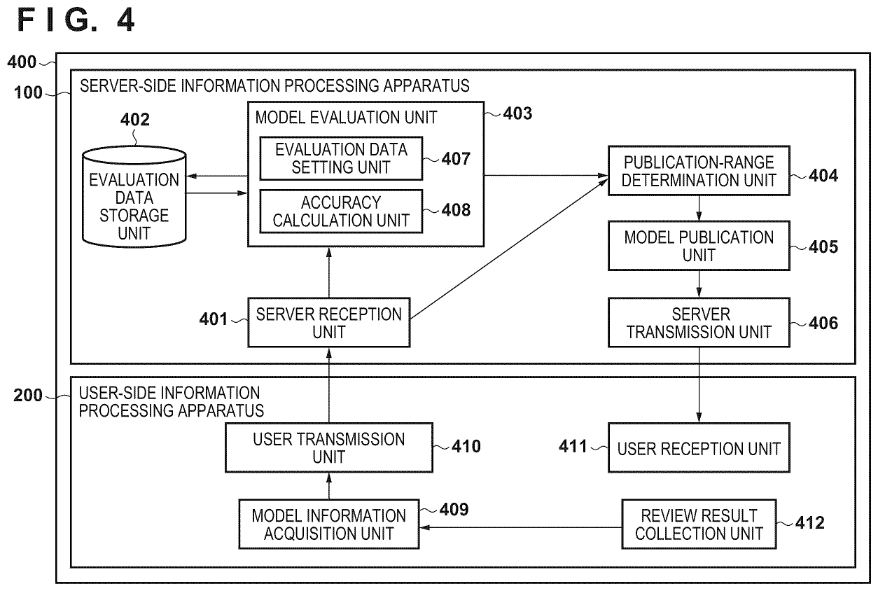

FIG. 4 illustrates a functional block diagram of an information processing system 400 according to the present embodiment. The server-side information processing apparatus 100 includes a server reception unit 401, an evaluation data storage unit 402, a model evaluation unit 403, a publication-range determination unit 404, a model publication unit 405, and a server transmission unit 406. Furthermore, the user-side information processing apparatus 200 includes a model information acquisition unit 409, a user transmission unit 410, a user reception unit 411, and a review result collection unit 412. The user transmission unit 410 and the server reception unit 401, and the server transmission unit 406 and the user reception unit 411 communicate information with one another via a network. However, FIG. 4 illustrates one example of a functional configuration, and does not limit the range of application of the present embodiment.

The server reception unit 401 receives information from the user-side information processing apparatus 200 via a network. The information received is model information of the trained model. In regard to the server reception unit 401, and the later-described server transmission unit 406, user transmission unit 410, and user reception unit 411, data is transmitted after being converted, prior to transmission, into a suitable format, and, after reception, the data is converted into that of a format that can be readily used at the output destination. For example, the model information may include: real data of the trained model; information such as the target of the trained model and the name of the user who trained the model; final review results from limited users; etc. However, the types of model information acquired are not limited to these, and may be real data of the model and any information relating to the model. The received model information is output to the model evaluation unit 403 and the publication-range determination unit 404.

The evaluation data storage unit 402 stores therein data for calculating an AI ethics-related evaluation accuracy r of the trained model. The evaluation accuracy r serves as a score of compliance with AI ethics, rather than that indicating the precision with which the trained model outputs correct answers. The data is classified by evaluation item and provided in various formats such as a dataset of animals likely to be erroneously detected as people, a dataset of buildings likely to be erroneously detected as people, and a dataset relating to people belonging to different races, and correct answer data is provided to each piece of data.

The model evaluation unit 403 receives the model information, and executes inference and evaluation of the trained model included in the model information to calculate the evaluation accuracy r. The model evaluation unit 403 includes an evaluation data setting unit 407 and an accuracy calculation unit 408. The evaluation data setting unit 407 specifies an AI-ethics evaluation item associated with the model information, and selects and sets appropriate evaluation data that is based on the evaluation item. Examples of the AI-ethics evaluation item include erroneous detection as people or objects other than people, racial fairness, etc.; however, the AI-ethics evaluation item need not be limited to one, and is not limited to such examples.

The accuracy calculation unit 408 calculates the evaluation accuracy r of the trained model using the selected evaluation data. The evaluation accuracy r indicates a comparable evaluation scale such as a value calculated by “100-erroneous detection rate (percentage)” or a standard deviation of accuracy rates for individual races. The accuracy calculation unit 408 adds the evaluation accuracy r and the AI-ethics evaluation item to the model information, and outputs the model information so obtained to the publication-range determination unit 404.

The publication-range determination unit 404 acquires the difference between the evaluation accuracy r included in the model information and a predetermined reference value s associated with each evaluation item, and determines a publication range of the trained model based on the difference. Note that, with respect to erroneous detection as people or objects other than people, racial fairness, etc., for example, the maximum value within the permissible range from the viewpoint of AI ethics is set as the reference values. The specific value of the reference value s is not limited; however, a high value may be set in order to reduce the risk of AI-ethics-related problems occurring in the market.

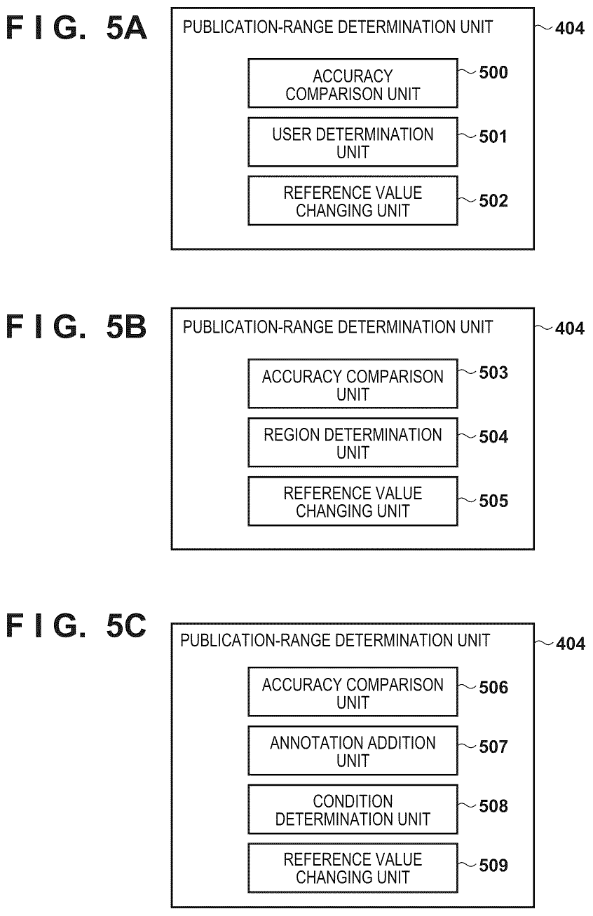

Here, FIG. 5A illustrates a functional block diagram of the publication-range determination unit 404 according to the present embodiment. The publication-range determination unit 404 includes an accuracy comparison unit 500, a user determination unit 501, and a reference value changing unit 502.

The accuracy comparison unit 500 compares the evaluation accuracy r calculated by the accuracy calculation unit 408 and the reference value s for the evaluation item set in advance based on AI ethics to acquire the difference therebetween. For example, the result of the comparison may be the difference between numerical values of the evaluation accuracy r and the reference value s, or a ratio between the numerical values (for example, evaluation accuracy r/reference value s). In the present embodiment, description is provided supposing that the result of the comparison is the difference between the numerical values.

Based on the difference between the reference values and the accuracy of the trained model acquired by the accuracy comparison unit 500, the user determination unit 501 determines users to which the trained model is to be published on the server. Based on the difference, the user determination unit 501 determines whether to publish the trained model to all users, to a limited subset of users, or to only the user who trained the trained model. Furthermore, the user determination unit 501 outputs the model information to the model publication unit 405 after adding the determined information to the model information. Hereinafter, the “limited subset of users” are referred to as “evaluating users”. The evaluating users are users who will provide review results by reviewing (evaluating) the trained model from the viewpoint of AI ethics. For example, the evaluating users may include around ten to twenty users.

The reference value changing unit 502 changes the reference value based on review results from the evaluating users that are included in the model information and that correspond to the trained model.

The model publication unit 405 receives information about the users determined as publication-target users, and outputs a model publication signal to the server transmission unit 406 so that the model information can be published only to the users determined as publication-target users. The server transmission unit 406 receives the model publication signal, and outputs the model information to the user reception unit 411 of the users determined as publication-target users in order to transmit the model information to the information processing apparatus 200 of the determined users based on the signal.

The model information acquisition unit 409 acquires information about the AI model trained by the user. Furthermore, the model information acquisition unit 409 outputs the acquired model information to the user transmission unit 410. The user transmission unit 410 receives the model information from the model information acquisition unit 409, and outputs the model information to the server reception unit 401 in order to transmit the model information to the server-side information processing apparatus 100. The user reception unit 411 receives information from the server-side information processing apparatus 100 via the network. The information received is the model information.

When the trained model has been published to the evaluating users, the review result collection unit 412 acquires review results obtained by an evaluating user reviewing the trained model from the viewpoint of AI ethics. A method of assigning a score using a 5-point or 10-point system, etc., can be mentioned as examples of the review method, but there is no limitation to this. In the present embodiment, description is provided supposing that the review method is a method of assigning a score using a 5-point system. The review result collection unit 412 calculates a final review result from the acquired review results, and outputs the final review result to the model information acquisition unit 409.

### Processing

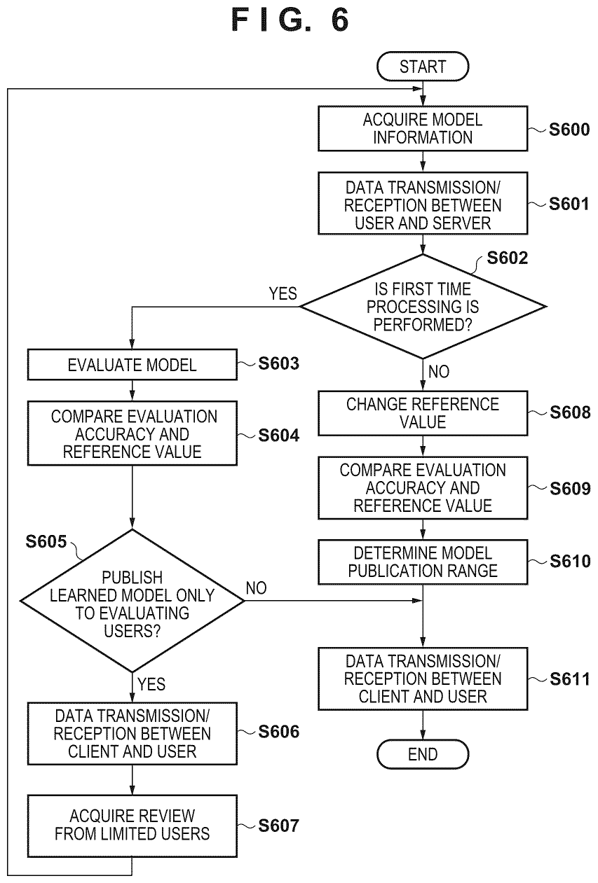

Next, processing executed by the information processing system 400 according to the present embodiment will be described in detail with reference to the flowchart in FIG. 6. For example, the processing illustrated in the flowchart in FIG. 6 is started upon input of model information trained by a user. Note that the information processing system does not necessarily have to execute all of the steps that will be described with reference to this flowchart.

In the present embodiment, the publication range of a trained AI model is determined based on the reference values and the evaluation accuracy r of the trained AI model. Specifically, the trained AI model is published to all users in a case where “evaluation accuracy r≥reference values” holds true. Also, the trained AI model is published to evaluating users, i.e., a subset of users who will evaluate the trained AI model, in a case where “evaluation accuracy r<reference value s and difference≤limit value t” hold true, or that is, in a case such as that in which the evaluation accuracy is slightly lower than the reference value. Furthermore, the trained AI model is published only to the user who trained the trained AI model in a case where “evaluation accuracy r<reference values and difference≥limit value t” hold true, or that is, in a case such as that in which the evaluation accuracy is significantly lower than the reference value.

As preparation prior to the execution of the present flowchart, the user-side information processing apparatus 200 performs system initialization. That is, the user-side information processing apparatus 200 is placed in an operable state by reading a program from the storage medium 202, which is a ROM. Furthermore, the server-side information processing apparatus 100 is similarly placed in an operable state. Then, a state is established in which the user-side information processing apparatus 200 and the server-side information processing apparatus 100 are capable of communicating with one another using the user transmission unit 410, the server reception unit 401, the server transmission unit 406, and the user reception unit 411.

In step S600, the model information acquisition unit 409 acquires the registered model information. The model information acquisition unit 409 performs data conversion on the acquired model information to compress and encrypt the model information into a format that is suitable for transmission. Then, the model information acquisition unit 409 outputs the model information to the user transmission unit 410.

In step S601, the user transmission unit 410 transmits, to the server reception unit 401, the model information received from the model information acquisition unit 409. The server reception unit 401 converts the received model information into the original format by performing data decryption and decompression. Then, the server reception unit 401 outputs the model information to the model evaluation unit 403 and the publication-range determination unit 404.

In step S602, the server-side information processing apparatus 100 determines whether or not the processing count of the processing in step S601 is 1. In a case where the processing count is 1, processing advances to step S603. On the other hand, in a case where the processing count is a value other than 1, processing advances to step S608.

In step S603, the evaluation data setting unit 407 of the model evaluation unit 403 specifies the AI-ethics evaluation item associated with the model information, and, based on the evaluation item, selects and sets the evaluation data to be used for evaluation from the evaluation data storage unit 402. Hereinafter, the data selected from the evaluation data storage unit 402 is referred to as an “evaluation set”. Furthermore, the accuracy calculation unit 408 executes inference and evaluation of the trained model with respect to the evaluation set to calculate the evaluation accuracy r. In the present embodiment, the target of the trained model is a specific person; thus, as the evaluation set, an image dataset for measuring erroneous detection as animals and buildings, which are different from the person, is selected.

The evaluation set is provided with image data, and also information of frames indicating the positions of target objects in the individual images. The results of inference by the trained model are constituted from information of frames indicating positions of objects detected as the specific person in the images in the evaluation set. The evaluation accuracy r is a value indicated by “100-erroneous detection rate (percentage)” when the inference results and the frame information of the evaluation set are compared. In other words, this means that accuracy in the sense that erroneous detection as objects other than the person is not performed is being measured. Here, for example, the evaluation accuracy r is 80%. The model evaluation unit 403 adds the obtained evaluation accuracy r and information about the selected evaluation set to the model information, and outputs the model information so obtained to the publication-range determination unit 404.

In step S604, the accuracy comparison unit 500 of the publication-range determination unit 404 compares the evaluation accuracy r and the preset reference value s for the AI-ethics evaluation item to acquire the difference therebetween. In the present embodiment, the AI-ethics evaluation item is the rate of erroneous detection as objects other than people, and the reference value s is 90%. The accuracy comparison unit 500 outputs the model information to the user determination unit 501 after adding the information about the acquired difference to the model information.

In step S605, the user determination unit 501 determines whether or not the trained model is to be published only to the evaluating users. Processing advances to step S606 in a case where the result of this step is “YES”. On the other hand, processing advances to step S611 in a case where the result of this step is “NO”.

The processing in step S605 will be described in detail in the following. First, based on the acquired difference, the user determination unit 501 determines users to which the trained model is to be published on the server. Furthermore, the model publication unit 405 receives information about the publication-target users, and outputs a model publication signal to the server transmission unit 406 so that the model information can be published only to the target users.

Specifically, in a case where the evaluation accuracy r is higher than or equal to the reference value s, the publication-range determination unit 404 determines to publish the trained model on the server to all users.

Furthermore, in a case where the evaluation accuracy r is lower than the reference value s and the difference is equal to or less than a preset limit value t, the publication-range determination unit 404 determines to publish the trained model on the server to the evaluating users. Here, the limit value t is 20%. The evaluating users are limited to people who can use the trained model and evaluate the model in terms of AI ethics. Furthermore, the evaluating users are people determined as being sufficiently trustworthy based on user information registered to the server. The number of evaluating users is not limited; however, the number of evaluating users may be limited to the minimum necessary number in order to reduce the risk of AI-ethics-related problems occurring in the market due to the trained model.

Furthermore, in a case where the evaluation accuracy r is lower than the reference values and the difference exceeds the preset limit value t, the publication-range determination unit 404 determines to publish the trained model on the server only to the user who trained the trained model. The publication-range determination unit 404 outputs the model information to the model publication unit 405 after adding, to the model information, information about the determined users of these three patterns.

The model publication unit 405 acquires, from the received model information, the information about the users determined as publication-target users. The model publication unit 405 outputs a model publication signal and the model information to the server transmission unit 406 so that the model information can be published only to the users determined as publication-target users.

In step S606, based on the model publication signal received from the model publication unit 405, the server transmission unit 406 transmits the model information only to the user reception unit 411 of the evaluating users. Furthermore, the user reception unit 411 converts the received model information into the original format by performing data decryption and decompression. The evaluating users can view and download the converted model information using the user-side information processing apparatus 200. Here, a case is assumed in which the user-side information processing apparatus 200 is a PC, and the trained model is downloaded to a single-lens reflex camera via the PC.

In step S607, the review result collection unit 412 acquires review results obtained by the evaluating users reviewing the trained model from the viewpoint of AI ethics. Based on the model information, each evaluating user checks the AI-ethics evaluation item for which the evaluation accuracy r did not reach the reference value s, and uses the single-lens reflex camera to which the trained model has been downloaded in a scene to which the evaluation item is applied. Here, because the problem is erroneous detection as objects other than the person, the evaluating user uses the single-lens reflex camera in a zoo, etc., for example, for a predetermined amount of time or more or to take pictures a predetermined number or times or more. After using the single-lens reflex camera, the evaluating user inputs, to the user-side information processing apparatus 200, a review of impressions regarding the AI-ethics evaluation item. The review period is not particularly limited; however, the review period can be set to a period that is long enough to evaluate AI-ethics-related problems caused by the trained model. After the review period, an average of the results of review by the evaluating users (for example, a rating of one to five stars in a rating scale of up to five stars) is calculated, and the calculated average is set as a final review result y. Here, suppose that the final review result y was 4.5. The review result collection unit 412 outputs the model information to the model information acquisition unit 409 after adding the final review result y to the model information. Then, processing returns to step S600.

The processing in step S608 is processing that is performed in a case where the result of the determination in step S602 is that the evaluation processing is not being performed for the first time. In step S608, the reference value changing unit 502 of the publication-range determination unit 404 acquires the final review result y from the model information, and changes the reference value s. The changed reference value is indicated by “s”. The reference value s can be changed according to Formula 1, for example; however, there is no limitation to this, and the reference value s can be changed, as appropriate, in accordance with the format of the final review result.

$$[ Formula 1 ]$$

$${s}^{′} = s - w * ( y - g ) \qquad ( 1 )$$

“w” in Formula 1 represents a weight for adopting the final review result, and “g” represents a value required for reviews. The required review value g is the minimum required value for publishing the trained model on the server on the scale of the final review result, and needs to be set in advance. If the final review result y exceeds the required value g, the reference values is changed in the direction in which the reference value s is lowered, by the amount by which the final review result y exceeds the required value g. If the final review result y does not exceed the required value g, the reference value s is changed in the direction in which the reference value s is increased, by the amount by which the final review result y does not exceed the required value g.

In step S609, the accuracy comparison unit 500 of the publication-range determination unit 404 compares the evaluation accuracy r and the reference value s′ changed by the reference value changing unit 502 to acquire the difference therebetween. In the present embodiment, the changed reference value is 75%. The accuracy comparison unit 500 outputs the model information to the user determination unit 501 after adding the information about the acquired difference to the model information.

In step S610, based on the information about the difference added to the acquired model information, the user determination unit 501 determines users to which the trained model is to be published on the server. Furthermore, the model publication unit 405 receives information about the publication-target users, and outputs a model publication signal to the server transmission unit 406 so that the model information can be published only to those users.

In a case where the evaluation accuracy r is higher than or equal to the changed reference value s′, the user determination unit 501 determines to publish the trained model on the server to all users. In a case where the evaluation accuracy r is lower than the changed reference value s′, the user determination unit 501 determines to publish the trained model on the server only to the user who trained the trained model. Then, the user determination unit 501 outputs the model information to the model publication unit 405 after adding, to the model information, information about the determined users. The model publication unit 405 acquires, from the received model information, the information about the users determined as publication-target users. Then, the model publication unit 405 outputs a model publication signal and the model information to the server transmission unit 406 so that the model information can be published only to the users determined as publication-target users.

In step S611, based on the model publication signal received from the model publication unit 405, the server transmission unit 406 transmits the model information only to the user reception unit 411 of the users determined as publication-target users in step S605 or S610. Furthermore, the user reception unit 411 converts the received model information into the original format by performing data decryption and decompression. The users determined as publication-target users can view and download the converted model information using the user-side information processing apparatus 200.

As described up to this point, in the present embodiment, information about a trained AI model is acquired from a user-side information processing apparatus and evaluated, and, based on the result of the evaluation, a publication range within which the server-side information processing apparatus will publish the trained AI model is determined.

According to the present embodiment, the trained model can be published to a server after selecting a user range to which the trained model is to be published and thereby reducing the risk of AI-ethics-related problems occurring in the market. The present embodiment makes it possible to also take AI ethics into consideration while stimulating the market by preventing a situation in which trained models are less likely to be published to the market due to AI ethics being handled overly cautiously.

### Second Embodiment

In the present embodiment, description will be provided of an example in which it is determined whether or not an AI model trained by a user complies with AI ethics, and regions (for example, the whole world, or a subset or countries or regions) to which the AI model is to be published are determined based on the result of the determination. In the present embodiment, description is provided taking as an example a situation in which one user has created an object detection model for detecting basketball players and is planning to publish the model. The system and apparatus configurations are the same as those in the first embodiment, and detailed description thereof is thus omitted.

### Functional Configuration

FIG. 5B illustrates a functional block diagram of the publication-range determination unit 404 included in the server-side information processing apparatus 100 according to the present embodiment. The publication-range determination unit 404 according to the present embodiment includes an accuracy comparison unit 503, a region determination unit 504, and a reference value changing unit 505.

The functions of the accuracy comparison unit 503 are the same as the functions of the accuracy comparison unit 500 described in the first embodiment, and description thereof is thus omitted.

Based on the difference between the reference values and the accuracy of the trained model acquired by the accuracy comparison unit 503, the region determination unit 504 determines regions to which the trained model is to be published on the server. In accordance with the difference, the region determination unit 504 determines whether to: publish the trained model to users in all regions around the world; publish the trained model to users in limited regions and to a subset of users outside the limited regions; or to publish the trained model only to the user who trained the trained model. Furthermore, the region determination unit 504 outputs the model information to the model publication unit 405 after adding the information to the model information. Hereinafter, the subset of users outside the limited regions are referred to as evaluating users.

The functions of the reference value changing unit 505 are the same as the functions of the reference value changing unit 502 described in the first embodiment, and description thereof is thus omitted.

The model publication unit 405 according to the present embodiment receives information about users in the regions determined as publication-target regions, and outputs a model publication signal to the server transmission unit 406 so that the model information can be published only to users in the regions determined as publication-target regions.

Based on the received model publication signal, the server transmission unit 406 according to the present embodiment outputs the model information to the user reception unit 411 of users in the determined regions in order to transmit the model information to the information processing apparatus 200 of the users in the regions determined as publication-target regions.

### Processing

Next, processing executed by the information processing system 400 according to the present embodiment will be described in detail with reference to the flowchart in FIG. 6.

In the present embodiment, the publication range of a trained AI model is determined based on the reference values and the evaluation accuracy r of the trained AI model. Specifically, in a case where the evaluation accuracy r is higher than or equal to the reference value s, it is determined that the trained AI model is to be published to users around the world. Also, in a case where the evaluation accuracy r is lower than the reference value s and the difference therebetween is equal to or less than a preset limit value t, it is determined that the trained AI model is to be published to users in a subset of regions. Furthermore, in a case where the evaluation accuracy r is lower than the reference value s and the difference therebetween exceeds the preset limit value t, the trained AI model is published only to the user who trained the trained AI model, as was the case in the first embodiment.

The processing in steps S600 to S602 is the same as the processing in steps S600 to S602 described in the first embodiment, and description thereof is thus omitted.

In step S603, the evaluation data setting unit 407 of the model evaluation unit 403 specifies the AI-ethics evaluation item associated with the model information, and, based on the evaluation item, selects and sets the evaluation data to be used for evaluation from the evaluation data storage unit 402. Hereinafter, the data selected from the evaluation data storage unit 402 is referred to as an “evaluation set”. Furthermore, the accuracy calculation unit 408 executes inference and evaluation of the trained model with respect to the evaluation set to calculate the evaluation accuracy r. In the present embodiment, the targets of the trained model are basketball players including players of various races; thus, as the evaluation set, an image dataset for measuring the detection accuracies for individual races is selected.

The evaluation set is provided with image data, and also information of frames indicating the positions of target objects included in the individual images. The results of inference by the trained model are constituted from information of frames indicating positions of objects detected as basketball players in the images in the evaluation set. The evaluation accuracy r is a value indicated by “100-[deviation of detection accuracies for individual races (percentages)]” when the inference results and the frame information of the evaluation set are compared. This indicates how small the difference between detection accuracies for individual races is, or in other words, racial fairness. Here, for example, the evaluation accuracy r is 75%. The model evaluation unit 403 adds the obtained evaluation accuracy r and information about the selected evaluation set to the model information, and outputs the model information so obtained to the publication-range determination unit 404.

In step S604, the accuracy comparison unit 503 of the publication-range determination unit 404 compares the evaluation accuracy r and the preset reference value s for the AI-ethics evaluation item to acquire the difference therebetween. In the present embodiment, the AI-ethics evaluation item is racial fairness, and the reference value s is 90%. The accuracy comparison unit 503 outputs the model information to the region determination unit 504 after adding the information about the acquired difference to the model information.

In step S605, the region determination unit 504 determines whether or not the trained model is to be published only to the evaluating users. Processing advances to step S606 in a case where the result of this step is “YES”. On the other hand, processing advances to step S611 in a case where the result of this step is “NO”.

The processing in step S605 will be described in detail in the following. First, based on the acquired difference, the region determination unit 504 determines regions to which the trained model is to be published on the server. Furthermore, the model publication unit 405 receives information about the publication-target regions, and outputs a model publication signal to the server transmission unit 406 so that the model information can be published only to users in the regions.

Specifically, in a case where the evaluation accuracy r is higher than or equal to the reference value s, the publication-range determination unit 404 determines to publish the trained model on the server to users in all regions. Also, in a case where the evaluation accuracy r is lower than the reference values and the difference is equal to or less than the preset limit value t, the publication-range determination unit 404 performs a comparison with a restriction value v set in advance for each region. The restriction value v is set for each region based on AI ethics formulated for the region. Here, suppose that the restriction value v for a given region is 10%. The limit value t is the minimum value among the restriction values v of all regions for which restriction values v are set, and, here, the limit value t is 30%.

As a result of the comparison, the publication-range determination unit 404 determines to publish the trained model on the server to regions for which the difference is equal to or less than the restriction value v. Furthermore, the publication-range determination unit 404 determines, as evaluating users, a subset of users in regions for which the difference exceeds the restriction value v, and determines to publish the trained model on the server to the evaluating users. The evaluating users are limited to people who can use the trained model and evaluate the model in terms of AI ethics. Furthermore, the evaluating users are people determined as being sufficiently trustworthy based on user information registered to the server. The number of evaluating users is not limited; however, at least one person is selected per region, and the number of evaluating users may be limited to the minimum necessary number in order to reduce the risk of AI-ethics-related problems occurring in the market due to the trained model.

Furthermore, in a case where the evaluation accuracy r is lower than the reference values and the difference exceeds the limit value t, the publication-range determination unit 404 determines to publish the trained model on the server only to the user who trained the trained model. The publication-range determination unit 404 outputs the model information to the model publication unit 405 after adding, to the model information, information about the determined regions and users.

The model publication unit 405 acquires, from the received model information, the information about the regions determined as publication-target regions. The model publication unit 405 outputs a model publication signal and the model information to the server transmission unit 406 so that the model information can be published only to the users in the regions determined as publication-target regions and the evaluating users.

The processing in step S606 is the same as the processing in step S606 in the first embodiment, and description thereof is thus omitted.

In step S607, the review result collection unit 412 acquires review results obtained by the evaluating users reviewing the trained model from the viewpoint of AI ethics. Based on the model information, an evaluating user checks the AI-ethics evaluation item for which the evaluation accuracy r did not reach the reference value s, and uses the single-lens reflex camera to which the trained model has been downloaded in a scene to which the evaluation item is applied. Here, because the problem is racial fairness among basketball players, the evaluating user uses the single-lens reflex camera for a predetermined amount of time or more or to take pictures a predetermined number of times or more at sport events, etc., which are opportunities to take pictures of people of various races, for example. After using the single-lens reflex camera, the evaluating user inputs, to the user-side information processing apparatus 200, a review of impressions regarding the AI-ethics evaluation item. The review period is not particularly limited; however, the review period can be set to a period that is long enough to evaluate AI-ethics-related problems caused by the trained model. After the review period, an average of the results of review by the evaluating users is calculated, and the calculated average is set as a final review result y. Here, suppose that the final review result y was 4.5. The review result collection unit 412 outputs the model information to the model information acquisition unit 409 after adding the final review result y to the model information. Then, processing returns to step S600.

The processing in each of steps S608 and S609 is the same as the processing in each of steps S608 and S609 described in the first embodiment, and description thereof is thus omitted.

In step S610, based on the information about the difference added to the acquired model information, the region determination unit 504 determines regions to which the trained model is to be published on the server. Furthermore, the model publication unit 405 receives information about the publication-target regions, and outputs a model publication signal to the server transmission unit 406 so that the model information can be published only to users in the publication-target regions.

In a case where the evaluation accuracy r is higher than or equal to the changed reference value s′, the region determination unit 504 determines to publish the trained model on the server to users in all regions of the world. In a case where the evaluation accuracy r is lower than the reference value s′ and the difference is equal to or less than the limit value t, the region determination unit 504 determines to publish the trained model on the server only to users in regions for which the difference is equal to or less than the restriction value v. In a case where the evaluation accuracy r is lower than the reference value s′ and the difference exceeds the limit value t, the region determination unit 504 determines to publish the trained model on the server only to the user who trained the trained model. Then, the region determination unit 504 outputs the model information to the model publication unit 405 after adding, to the model information, information about the determined regions. The model publication unit 405 acquires, from the received model information, the information about the regions determined as publication-target regions. Then, the model publication unit 405 outputs a model publication signal and the model information to the server transmission unit 406 so that the model information can be published only to users in the regions determined as publication-target regions.

In step S611, based on the model publication signal received from the model publication unit 405, the server transmission unit 406 transmits the model information only to the user reception unit 411 of users in the regions determined as publication-target regions in step S605 or S610. Furthermore, the user reception unit 411 converts the received model information into the original format by performing data decryption and decompression. Users in the regions determined as publication-target regions can view and download the converted model information using the user-side information processing apparatus 200.

As described up to this point, according to the present embodiment, the trained model can be published to a server after selecting regions to which the trained model is to be published and thereby reducing the risk of AI-ethics-related problems occurring in the regions.

### Third Embodiment

In the present embodiment, description will be provided of an example in which it is determined whether or not an AI model trained by a user complies with AI ethics, and users and a condition for publishing the AI model are determined based on the result of the determination. In the present embodiment, description is provided taking as an example a case in which a given user has created an object detection model for detecting a specific person and is planning to publish the model, as was the case in the first embodiment. The system and apparatus configurations are the same as those in the first embodiment, and detailed description thereof is thus omitted.

### Functional Configuration

FIG. 5C illustrates a functional block diagram of the publication-range determination unit 404 included in the server-side information processing apparatus 100 according to the present embodiment. The publication-range determination unit 404 according to the present embodiment includes an accuracy comparison unit 506, an annotation addition unit 507, a condition determination unit 508, and a reference value changing unit 509.

The functions of the accuracy comparison unit 506 are the same as the functions of the accuracy comparison unit 500 described in the first embodiment, and description thereof is thus omitted.

Based on the difference between the reference value s and the accuracy of the trained model acquired by the accuracy comparison unit 506, the annotation addition unit 507 adds an annotation for publishing the trained model. The content of the annotation will be described in detail later. Furthermore, the annotation addition unit 507 outputs, to the condition determination unit 508, model information and information about the difference acquired by the accuracy comparison unit 506 after adding the information about the annotation to the model information.

With respect to the trained model to which the annotation has been added by the annotation addition unit 507, the condition determination unit 508 determines a publication condition so that the model can be published only to users who have agreed with the content of the annotation. Furthermore, the condition determination unit 508 determines, from among all users, a subset of users who can evaluate the trained model. Hereinafter, the subset of users are referred to as evaluating users. In a case where the annotation information is not added to the trained model, the condition determination unit 508 determines, based on the information about the difference, whether the trained model is to be published to all users or only to the user who trained the trained model. The condition determination unit 508 outputs the model information to the model publication unit 405 after adding the determined information to the model information.

The functions of the reference value changing unit 509 are the same as those of the reference value changing unit 502 described in the first embodiment, and description thereof is thus omitted.

The model publication unit 405 receives the model information, and, in a case where the annotation information is added to the trained model, outputs a model publication signal to the server transmission unit 406 so that the model information can be published only to users who meet the publication condition. Furthermore, in cases other than this, the model publication unit 405 outputs a model publication signal to the server transmission unit 406 so that the model information can be published only to users determined as publication-target users.

### Processing

Next, processing executed by the information processing system 400 according to the present embodiment will be described in detail with reference to the flowchart in FIG. 6.

In the present embodiment, the publication range of a trained AI model is determined based on the reference values and the evaluation accuracy r of the trained AI model. For example, in a case where the evaluation accuracy r is lower than the reference value s and the difference therebetween is equal to or less than the preset limit value t, annotation information is added to the trained AI model and it is determined that the trained AI model is to be published to users who have agreed with the content of the annotation information.

The processing in steps S600 to S603 is the same as the processing in steps S600 to S603 described in the first embodiment, and description thereof is thus omitted.

In step S604, the accuracy comparison unit 506 of the publication-range determination unit 404 compares the evaluation accuracy r and the preset reference value s for the AI-ethics evaluation item to acquire the difference therebetween. In the present embodiment, the AI-ethics evaluation item is the rate of erroneous detection as objects other than people, and the reference value s is 90%. The accuracy comparison unit 506 outputs the model information to the annotation addition unit 507 after adding the information about the acquired difference to the model information.

In step S605, the publication-range determination unit 404 determines whether or not the trained model is to published only to the evaluating users. Processing advances to step S606 in a case where the result of this step is “YES”. On the other hand, processing advances to step S611 in a case where the result of this step is “NO”.

The processing in step S605 will be described in detail in the following. First, based on the acquired difference, the annotation addition unit 507 adds an annotation for publishing the trained model on the server. Next, based on the difference and the presence/absence of the annotation, the condition determination unit 508 determines users and a condition for publishing the trained model on the server. Finally, the model publication unit 405 receives information about the users and the condition for publication, and outputs a model publication signal to the server transmission unit 406 so that the model information can be published only to users meeting the condition and users determined as publication-target users.

In a case where the evaluation accuracy r is lower than the reference value s and the difference is equal to or less than the preset limit value t, the annotation addition unit 507 adds the annotation to the trained model. Here, the limit value t is 20%. For example, annotations such as “Due to there being an item that is problematic in terms of AI ethics, use in scenes to which the item is expected to be applied should be avoided” and “Do not share results of use of the model on SNS” can be mentioned as examples of the annotation information; however, there is no limitation to these examples. Furthermore, in a case where the annotation is added to the trained model, it is determined that the model is to be published so that only users who have read the annotation and agreed with the content thereof can download the model.

In addition, in a case where the annotation information is added, evaluating users who are to review the model are selected from among all users. The evaluating users are limited to people who can use the trained model and evaluate the model in terms of AI ethics. Furthermore, the evaluating users are people determined as being sufficiently trustworthy based on user information registered to the server. The number of evaluating users is not limited; however, the number of evaluating users may be limited to the minimum necessary number in order to reduce the risk of AI-ethics-related problems occurring in the market due to the trained model.

Furthermore, in a case where the evaluation accuracy r is higher than or equal to the reference value s, the publication-range determination unit 404 determines to unconditionally publish the trained model on the server to all users. In a case where the evaluation accuracy r is lower than the reference values and the difference exceeds the preset limit value t, the publication-range determination unit 404 determines to unconditionally publish the trained model on the server only to the user who trained the trained model. The publication-range determination unit 404 outputs the model information to the model publication unit 405 after adding the determined information to the model information.

The model publication unit 405 acquires, from the received model information, information about the condition for publication and the users determined as publication-target users. The model publication unit 405 outputs a model publication signal and the model information to the server transmission unit 406 so that the model information can be published only to users meeting the condition for publication and the users determined as publication-target users.

The processing in each of steps S606 to S609 is the same as the processing in each of steps S606 to S609 described in the first embodiment, and description thereof is thus omitted.

In step S610, based on the acquired difference, the annotation addition unit 507 adds the annotation for publishing the trained model on the server. Next, based on the difference and the presence/absence of the annotation, the condition determination unit 508 determines users and a condition for publishing the trained model on the server. Finally, the model publication unit 405 receives information about the users and the condition for publication, and outputs a model publication signal to the server transmission unit 406 so that the model information can be published only to users meeting the condition and users determined as publication-target users.

In a case where the evaluation accuracy r is lower than the reference value s′ and the difference is equal to or less than the preset limit value t, the annotation addition unit 507 adds the annotation to the trained model. Furthermore, in a case where the annotation is added to the trained model, the annotation addition unit 507 determines to publish the model so that only users who have read the annotation and agreed with the content thereof can download the model.

In a case where the evaluation accuracy r is higher than or equal to the reference value s′, the annotation addition unit 507 determines to unconditionally publish the trained model on the server to all users. In a case where the evaluation accuracy r is lower than the reference value s′ and the difference exceeds the preset limit value t, the model publication unit 405 determines to unconditionally publish the trained model on the server only to the user who trained the trained model.

The annotation addition unit 507 outputs the model information to the model publication unit 405 after adding the determined information described above to the model information. The model publication unit 405 acquires, from the received model information, information about the condition for publication and the users determined as publication-target users. The model publication unit 405 outputs a model publication signal and the model information to the server transmission unit 406 so that the model information can be published only to users meeting the condition for publication and the users determined as publication-target users.

In step S611, in response to the model publication signal received from the model publication unit 405, the server transmission unit 406 transmits the model information only to the user reception unit 411 of the users meeting the condition and the users determined as publication-target users in steps S605 and S610. Furthermore, the user reception unit 411 converts the received model information into the original format by performing data decryption and decompression. Users meeting the condition and users determined as publication-target users can view and download the converted model information using the user-side information processing apparatus 200.

As described up to this point, according to the present embodiment, upon publication of a trained model with an AI ethics-related problem, an annotation is provided to the model so that the model can be published to users who have agreed with the annotation. The risk of AI-ethics-related problems occurring in the market can be reduced by ensuring that the users can use the trained model after understanding the AI-ethics-related problem with the trained model from the annotation.

According to the present invention, the risk of AI-ethics-related problems occurring due to an AI model published by a user can be reduced.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-013304, filed Jan. 31, 2024, which is hereby incorporated by reference herein in its entirety.

What is claimed is:

1. An information processing apparatus that can communicate with another information processing apparatus, the information processing apparatus comprising:
an acquisition unit configured to acquire information about a trained AI model from the other information processing apparatus;
an evaluation unit configured to evaluate the trained AI model; and
a determination unit configured to, based on a result of the evaluation by the evaluation unit, determine a publication range within which the information processing apparatus will publish the trained AI model.

2. The information processing apparatus according to claim 1,
wherein the evaluation unit comprises:
a setting unit configured to specify an AI-ethics evaluation item based on the information about the trained AI model and set evaluation data corresponding to the evaluation item; and
a calculation unit configured to calculate an evaluation accuracy of the trained AI model based on the evaluation data.

3. The information processing apparatus according to claim 2,
wherein the determination unit determines the publication range of the trained AI model based on the evaluation accuracy of the trained AI model and a reference value associated with the evaluation item.

4. The information processing apparatus according to claim 3,
wherein, in a case where the evaluation accuracy is higher than or equal to the reference value, the determination unit determines to publish the trained AI model to all users.

5. The information processing apparatus according to claim 3,
wherein, in a case where the evaluation accuracy is lower than the reference value, and a difference between the evaluation accuracy and the reference value is equal to or less than a preset limit value, the determination unit determines to publish the trained AI model to evaluating users, who are a subset of users who will evaluate the trained AI model.

6. The information processing apparatus according to claim 3,
wherein, in a case where the evaluation accuracy is lower than the reference value, and a difference between the evaluation accuracy and the reference value exceeds a preset limit value, the determination unit determines to publish the trained AI model to a user who trained the trained AI model.

7. The information processing apparatus according to claim 3,
wherein, in a case where the evaluation accuracy is higher than or equal to the reference value, the determination unit determines to publish the trained AI model to the whole world.

8. The information processing apparatus according to claim 3,
wherein, in a case where the evaluation accuracy is lower than the reference value, and a difference between the evaluation accuracy and the reference value is equal to or less than a preset limit value, the determination unit determines to publish the trained AI model in a subset of regions.

9. The information processing apparatus according to claim 3,
wherein, in a case where the evaluation accuracy is lower than the reference value, and a difference between the evaluation accuracy and the reference value is equal to or less than a preset limit value, the determination unit adds annotation information to the trained AI model and determines to publish the trained AI model to one or more users who have agreed with the content of the annotation information.

10. The information processing apparatus according to claim 5 further comprising:
an acquisition unit configured to acquire results of review of the trained AI model by the evaluating users; and
a changing unit configured to change the reference value based on the results of review.

11. The information processing apparatus according to claim 1 further comprising:
a publication unit configured to publish the trained AI model based on the publication range.

12. A method for controlling an information processing apparatus that can communicate with another information processing apparatus, the method comprising:
acquiring information about a trained AI model from the other information processing apparatus;
evaluating the trained AI model; and
based on a result of the evaluation in the evaluating, determining a publication range within which the information processing apparatus will publish the trained AI model.

13. A non-transitory computer-readable storage medium storing therein a program for causing a computer to execute a method for controlling an information processing apparatus that can communicate with another information processing apparatus, the method comprising:
acquiring information about a trained AI model from the other information processing apparatus;
evaluating the trained AI model; and
based on a result of the evaluation in the evaluating, determining a publication range within which the information processing apparatus will publish the trained AI model.
